(19) United States
(12) Patent Application Publication
(10) Pub. No.: US 2009/0147527 A1
(43) Pub. Date: Jun. 11, 2009

(54) Electric Fixture Holder for Ladder

(75) Inventor: Jim O'Connor, Halfmoon Bay, CA (US)

Correspondence Address: MARTINE PENILLA & GENCARELLA, LLP, 710 LAKEWAY DRIVE, SUITE 200, SUNNYVALE, CA, 94085, US

(73) Assignee: Cupertino Electric Inc., San Jose, CA (US)

(21) Appl. No.: 12/331,213

(22) Filed: Dec. 9, 2008

Related U.S. Application Data
(60) Provisional application No. 61/012,909, filed on Dec. 11, 2007.

(51) Int. Cl. F21V 21/08; F21V 21/00

(52) U.S. Cl. 362/396; 362/382

(57) ABSTRACT

A mounting member is defined to be secured to a number of rungs of the ladder. A fixture support is affixed to a side of the mounting member that faces away from the ladder when the mounting member is secured to the ladder. The fixture support is defined to receive and support an electric fixture.

### CLAIM OF PRIORITY

This application claims priority under 35 U.S.C. 119(e) to U.S. Provisional Patent Application No. 61/012,909, filed Dec. 11, 2007. This provisional application is incorporated herein by reference.

### BACKGROUND

Electricians often install electrical fixtures in overhead locations. The electricians generally carry the electrical fixture as they climb a ladder to reach a sufficient height at which the electrical fixture can be installed. Climbing a ladder while carrying an electrical fixture, and possibly other tools, does not allow the electrician to maintain three points of contact with the ladder. Safe occupational practice requires that the electrician maintain three points of contact with the ladder while climbing. Therefore, it is often unsafe to carry an electrical fixture, particularly a large electrical fixture, while climbing the ladder. Consequently, a solution is sought to enable the electrician to safely climb the ladder while also providing the electrician with at-height access to the electrical fixture to be installed.

### SUMMARY OF THE INVENTION

In one embodiment, an electric fixture holder for a ladder is disclosed. The electric fixture holder includes a mounting member defined to be secured to a number of rungs of the ladder. The electric fixture holder also includes a fixture support affixed to a side of the mounting member that faces away from the ladder when the mounting member is secured to the ladder. The fixture support is defined to receive and support an electric fixture.

In another embodiment, a method is disclosed for installing an electric fixture. The method includes an operation for securing an electric fixture holder to a non-climbing side of a ladder. An operation is then performed to place an electric fixture in the electric fixture holder. A person then climbs a climbing side of the ladder to a height at which an installation location for the electric fixture is reachable. The method then includes an operation for retrieving the electric fixture from the electric fixture holder for installation.

Other aspects and advantages of the invention will become more apparent from the following detailed description, taken in conjunction with the accompanying drawings, illustrating by way of example the present invention.

### BRIEF DESCRIPTION OF THE DRAWINGS

FIG. 1 is an illustration showing an electric fixture holder for mounting on a ladder, in accordance with one embodiment of the present invention;

FIG. 2 is an illustration showing an isolated front view of the fixture support, in accordance with one embodiment of the present invention, FIG. 3 is an illustration showing a side view A-A of the fixture support, as called out in FIG. 2;

FIG. 4 is an illustration showing a back view of the fixture holder, in accordance with one embodiment of the present invention;

FIG. 5 is an illustration showing a side view B-B of the fixture holder, as called out in FIG. 4;

FIG. 6A is an illustration showing a side view of a ladder with the fixture holder secured to the non-climbing side of the ladder, in accordance with one embodiment of the present invention;

FIG. 6B is an illustration showing a vertical cross-section cut through the center of the ladder as shown in FIG. 6A;

FIG. 7A is an illustration showing a person placing an electric fixture into the fixture support;

FIG. 7B is an illustration showing the person climbing the ladder, as the electric fixture is being held by the fixture holder; and

FIG. 8 shows a flowchart of a method for installing an electric fixture, in accordance with one embodiment of the present invention.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

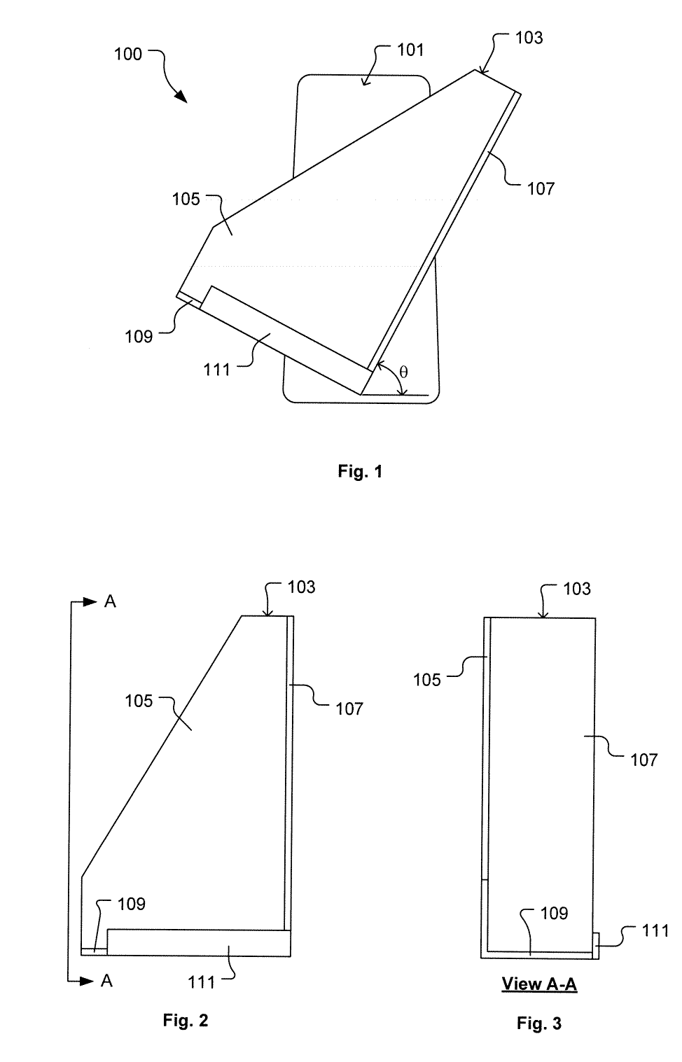

FIG. 1 is an illustration showing an electric fixture holder 100 for mounting on a ladder, in accordance with one embodiment of the present invention. The fixture holder 100 includes a mounting member 101 and a fixture support 103. In one embodiment, each component of the mounting member 101 and the fixture support 103 are formed of aluminum metal. However, in other embodiments, the components of the mounting member 101 and the fixture support 103 can be formed of essentially any type of material capable of providing sufficient strength and durability. The mounting member 101 is defined to be secured to a number of rungs of a non-climbing side of a ladder. The fixture support 103 is affixed to a side of the mounting member 101 that is to face away from the ladder when the fixture holder 100 is mounted on the ladder. In one embodiment, the fixture support 103 is welded to the mounting member 101. However, in other embodiments the fixture support 103 can be connected to the mounting member 101 in essentially any manner that maintains a fixed relationship between the fixture support 103 and the mounting member 101, without interfering with the ladder or an electric fixture to be held in the fixture support 103. For example, in one embodiment, the fixture support 103 can be connected to the mounting member 101 using threaded fasteners.

In one embodiment, the fixture support 103 is affixed to the mounting member 101 at an angle θ relative to horizontal, such that the fixture support 103 is oriented at the angle θ when the mounting member 101 is secured to the ladder. More specifically, because the mounting member 101 will be mounted in a substantially vertical manner with respect to the non-climbing side of the ladder, the fixture support 103 will be oriented at the angle θ relative to the horizontal rungs of the non-climbing side of the ladder. The angle θ at which the fixture support 103 is oriented relative to the mounting member 101 is defined such that a center of mass of an electric fixture to be held in the fixture support 103 will be substantially centered on the mounting member 101.

The fixture support 103 includes a back side 105 which is affixed to the mounting member 101. The fixture support 103 also includes a first support side 107 and a second support side 109. The first and second support sides 107/109 are defined to receive and support the electric fixture to be held by the fixture support 103. The fixture support 103 further includes a retaining structure 111 defined to extend up from the support side 109 so as to prevent the electric fixture from falling when present on the fixture support 103 between the first and second support sides 107/109.

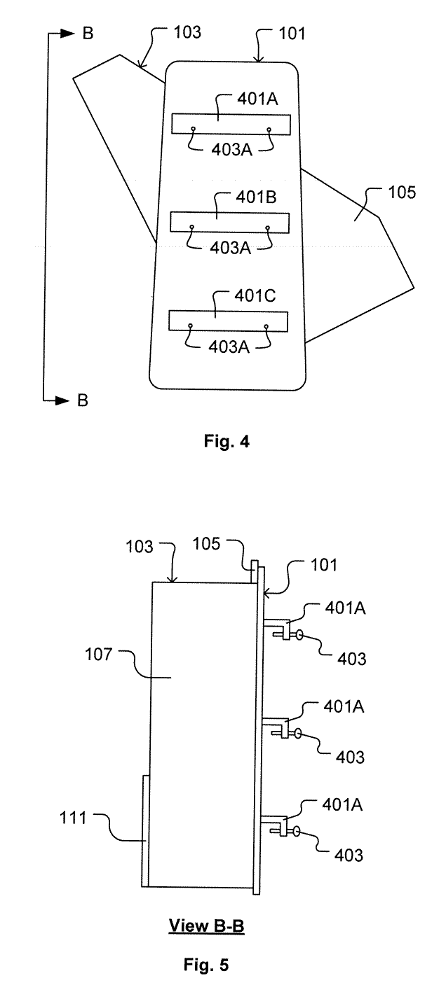

FIG. 2 is an illustration showing an isolated front view of the fixture support 103, in accordance with one embodiment of the present invention. In other words, FIG. 2 shows a front view of the fixture support 103 detached from the mounting member 101. FIG. 3 is an illustration showing a side view A-A of the fixture support 103, as called out in FIG. 2. As shown in FIGS. 2 and 3, the fixture support 103 is open on each side thereof opposite from the first and second support sides 107/109. This enables the electric fixture to be easily placed in and removed from the fixture support 103.

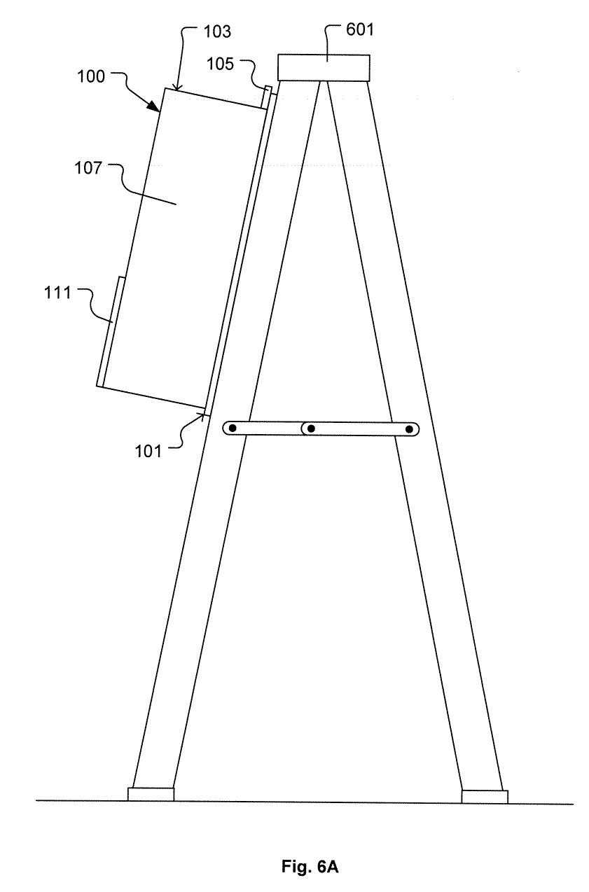

FIG. 4 is an illustration showing a back view of the fixture holder 100, in accordance with one embodiment of the present invention. The back side of the fixture holder 100 corresponds to a back side of the mounting member 101 that is to be positioned against the non-climbing side of the ladder. A number of mounting structures 401A-401C are affixed to the back side of the mounting member 101. In one embodiment, the mounting structures 401A-401C are welded to the back side of the mounting member 101. However, in other embodiments, the mounting structures 401A-401C can be secured to the back side of the mounting member 101 by fasteners. In one embodiment, each mounting structure 401A-401C includes a number of threaded holes 403A through which thumb screws or other types of fasteners can threaded to engage the rungs of the non-climbing side of the ladder.

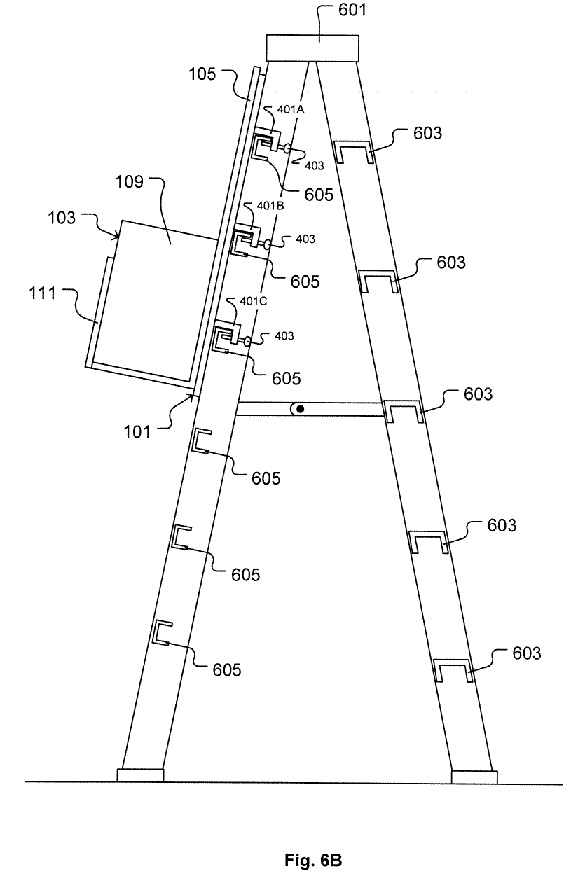

FIG. 5 is an illustration showing a side view B-B of the fixture holder 100, as called out in FIG. 4. In one embodiment, the mounting structures 401A-401C are defined as L-shaped structures extending outward from the back side of the mounting member 101 then downward. In this embodiment, each of the mounting structures 401A-401C is sized to hook over a top surface of a respective rung of the non-climbing side of the ladder. Also, in this embodiment, each of the mounting structures 401A-401C is positioned on the back side of the mounting member 101 so as to align with a respective rung of the non-climbing side of the ladder, such that the mounting member 101 can be applied to the non-climbing side of the ladder, and then lowered to simultaneously engage each of the mounting structures 401A-401C to its respective ladder rung. Also, as shown in FIG. 5, a number of thumb screws 403 can be threaded through the holes 403A in the each of the mounting structures 401A-401C to engage the ladder rungs, thereby securing the fixture holder 100 to the ladder.

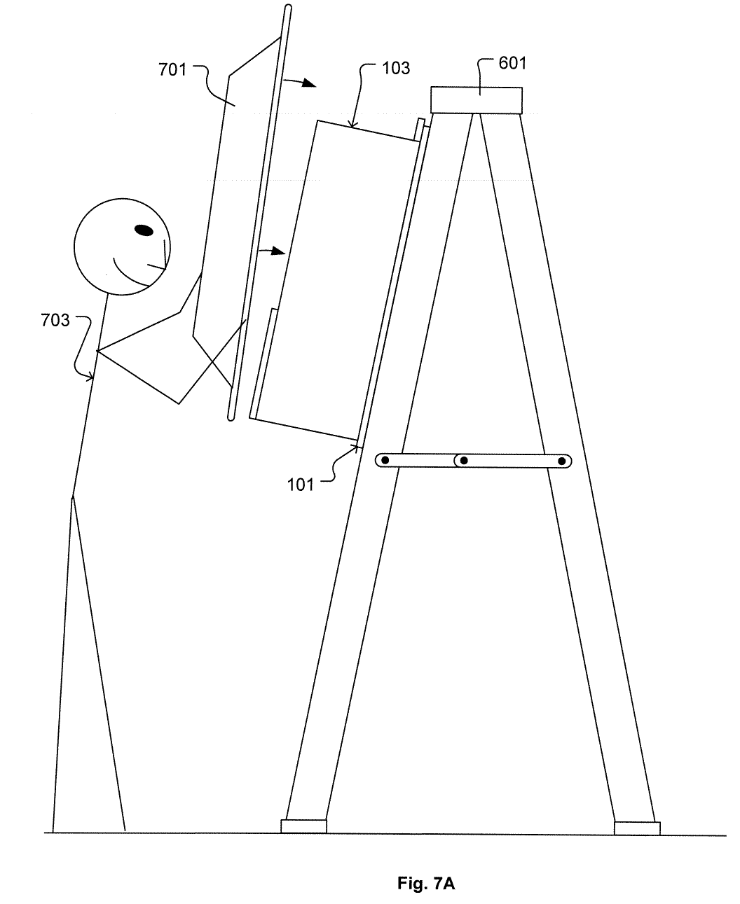

FIG. 6A is an illustration showing a side view of a ladder 601 with the fixture holder 100 secured to the non-climbing side of the ladder 601, in accordance with one embodiment of the present invention. FIG. 6B is an illustration showing a vertical cross-section cut through the center of the ladder 601 as shown in FIG. 6A. The ladder 601 includes a number of rungs 605 on the non-climbing side, and a number of steps 603 on the climbing side. The fixture holder 100 is secured to the ladder 601 by placing each of the mounting structures 401A-401C (on the back side of the mounting member 101) over a respective one of the ladder rungs 605 on the non-climbing side of the ladder 601. The thumb screws 403 are shown to be engaged with the ladder rungs 605 so as to secure the mounting member 101 to the ladder 601, and thereby secure the fixture holder 100 to the ladder 601. It should be appreciated that modification of the ladder 601 is not required to secure the fixture holder 100 to the ladder 601.

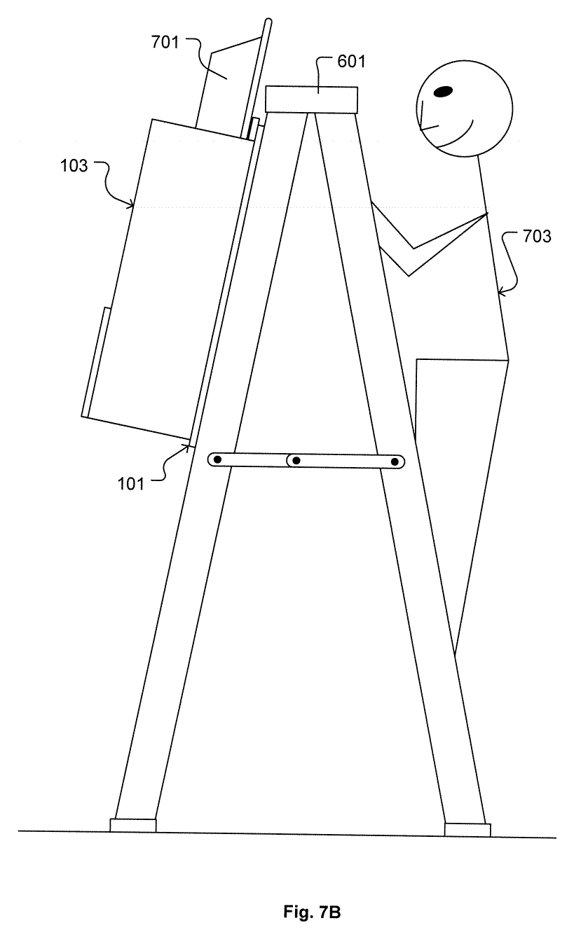

FIG. 7A is an illustration showing a person 703 placing an electric fixture 701 into the fixture support 103. In one embodiment, the fixture holder 100 is mounted to the ladder 601 at a height that allows the electric fixture 701 to be loaded into the fixture support 103 by a person standing on the ground, and that allows the electric fixture 701 to also be reached by a person standing at an upper portion of the climbing side of the ladder 601.

FIG. 7B is an illustration showing the person 703 climbing the ladder 601, as the electric fixture 701 is being held by the fixture holder 100. Because the person 703 does not have to carry the electric fixture 701 with them as they climb the ladder 601, the person 703 is able to safely climb the ladder 601 while maintaining at least three points of contact with the ladder 601. It should be understood that the electric fixture 701 can be essentially any type of electric fixture that needs to be accessible to the person 703 at an elevated position on the ladder 601. For example, in one embodiment, the electric fixture may be a 2 ft.×4 ft. light fixture. Also, it should be understood that the fixture holder 100 can be used with essentially any size and/or height ladder 601. Furthermore, it should be understood that the number, size, and configuration/shape of the mounting structures 401A-401C on the back side of the mounting member 101 can be varied as necessary to accommodate any given ladder configuration.

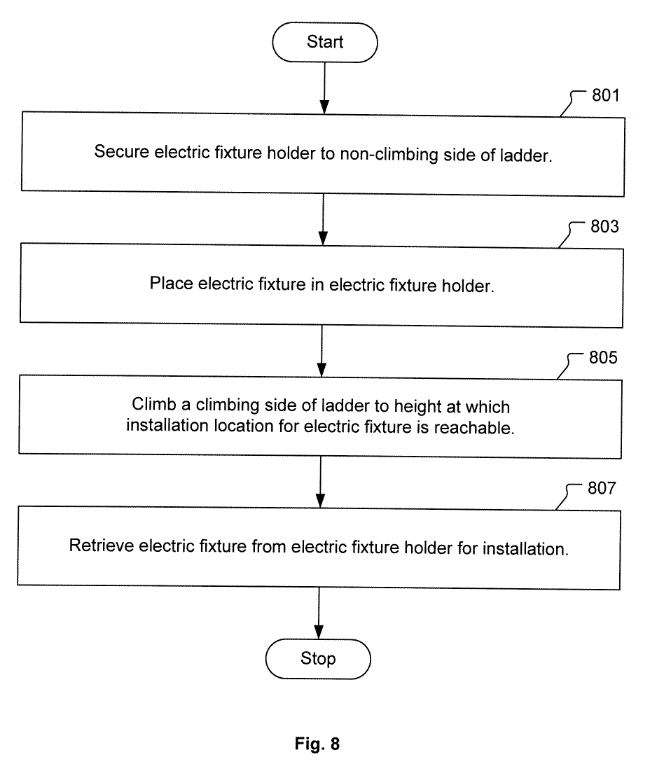

FIG. 8 shows a flowchart of a method for installing an electric fixture, in accordance with one embodiment of the present invention. The method includes an operation 801 for securing an electric fixture holder to a non-climbing side of a ladder. In one embodiment, the electric fixture holder is secured to the non-climbing side of the ladder at a height that is accessible from a ground level, i.e., accessible by a person standing on the ground. The method also includes an operation 803 for placing an electric fixture in the electric fixture holder. Then, in an operation 805, a person climbs a climbing side of the ladder to a height at which an installation location for the electric fixture is reachable. In one embodiment, the installation location may be an electrical box in a ceiling. It should be appreciated that because the electric fixture is held by the electric fixture holder, the person is able to climb the ladder without carrying the electric fixture. Therefore, the person is able to maintain three points of contact when climbing the ladder. The method continues with an operation 807 for retrieving the electric fixture from the electric fixture holder for installation.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. An electric fixture holder for a ladder, comprising:
a mounting member defined to be secured to a number of rungs of the ladder; and
a fixture support affixed to a side of the mounting member that faces away from the ladder when the mounting member is secured to the ladder, wherein the fixture support is defined to receive and support an electric fixture.

2. An electric fixture holder for a ladder as recited in claim 1, wherein the fixture support is affixed to the mounting member so as to maintain a fixed spatial relationship between the fixture support and the mounting member.

3. An electric fixture holder for a ladder as recited in claim 1, wherein the fixture support is affixed to the mounting member at an angle relative to horizontal such that the fixture support will be oriented at the angle relative to horizontal when the mounting member is secured to the ladder.

4. An electric fixture holder for a ladder as recited in claim 3, wherein the angle is set such that a center of mass of the electric fixture is substantially centered on the mounting member when the electric fixture is supported by the fixture support.

5. An electric fixture holder for a ladder as recited in claim 1, wherein the fixture support includes two support sides defined to support the electric fixture.

6. An electric fixture holder for a ladder as recited in claim 5, wherein the two support sides are disposed in a perpendicular relationship to each other on adjacent sides of the fixture support.

7. An electric fixture holder for a ladder as recited in claim 1, further comprising:
a number of mounting structures affixed to a back side of the mounting member, wherein each of the number of mounting structures is defined to hook over a respective rung of the ladder.

8. An electric fixture holder for a ladder as recited in claim 7, wherein each of the number of mounting structures includes a number of fasteners for securing the mounting structure to the respective rung of the ladder.

9. A method for installing an electric fixture, comprising:
securing an electric fixture holder to a non-climbing side of a ladder;
placing an electric fixture in the electric fixture holder;
climbing a climbing side of the ladder to a height at which an installation location for the electric fixture is reachable; and
retrieving the electric fixture from the electric fixture holder for installation.

10. A method for installing an electric fixture as recited in claim 9, wherein the electric fixture holder is secured to the non-climbing side of the ladder at a height that is accessible from a ground level.

11. A method for installing an electric fixture as recited in claim 9, wherein the electric fixture holder includes:
a mounting member defined to be secured to a number of rungs of the non-climbing side of the ladder, and
a fixture support affixed to a side of the mounting member that faces away from the ladder when the mounting member is secured to the ladder, wherein the fixture support is defined to receive and support the electric fixture.

12. A method for installing an electric fixture as recited in claim 11, wherein the fixture support is affixed to the mounting member so as to maintain a fixed spatial relationship between the fixture support and the mounting member.

13. A method for installing an electric fixture as recited in claim 11, wherein the fixture support is affixed to the mounting member at an angle relative to horizontal such that the fixture support will be oriented at the angle relative to horizontal when the mounting member is secured to the ladder.

14. A method for installing an electric fixture as recited in claim 13, further comprising:
setting the angle such that a center of mass of the electric fixture is substantially centered on the mounting member when the electric fixture is supported by the fixture support.

15. A method for installing an electric fixture as recited in claim 11, wherein the fixture support includes two support sides defined to support the electric fixture.

16. A method for installing an electric fixture as recited in claim 15, wherein the two support sides are disposed in a perpendicular relationship to each other on adjacent sides of the fixture support.

17. A method for installing an electric fixture as recited in claim 11, wherein the electric fixture holder includes:
a number of mounting structures affixed to a back side of the mounting member, wherein each of the number of mounting structures is defined to hook over a respective rung of the ladder.

18. A method for installing an electric fixture as recited in claim 17, wherein securing the electric fixture holder to the non-climbing side of the ladder includes hooking the number of mounting structures over a corresponding number of rungs of the ladder, and fastening the number of mounting structures to the corresponding number of rungs of the ladder.
